(19) United States
(12) Patent Application Publication
(10) Pub. No.: US 2026/0095485 A1
(43) Pub. Date: Apr. 2, 2026

(54) METHOD FOR APPLICATION ACCESS IN ZERO TRUST CAMPUS NETWORK

(71) Applicant: Extreme Networks, Inc., San Jose, CA (US)

(72) Inventors: Donald B. GROSSER, Apex, NC (US); Mahendra Samarya, Fremont, CA (US); Charles Bickford, Needham, MA (US); Kevin Yohe, II, Bow, NH (US); Suveena James, Leander, TX (US); Michael Brady, Durham, NH (US)

(73) Assignee: Extreme Networks, Inc., San Jose, CA (US)

(21) Appl. No.: 18/902,289

(22) Filed: Sep. 30, 2024

(51) Int. Cl. H04L 9/40

(52) U.S. Cl. CPC H04L 63/20; H04L 63/029; H04L 63/0876

(57) ABSTRACT

Disclosed herein are system, method, and computer program product aspects for providing an agent-based zero trust network access (ZTNA) remote device access to a campus network. Some aspects of this disclosure relate to a universal network access application including a memory and a processor. The processor is configured to receive an authentication request from a client device and in response to receiving the authentication request, retrieve a set of network policies indicating an Internet protocol (IP) address and a port number based on the authentication request. The processor is further configured to transmit the set of network policies to a policy enforcement application in a campus network.

### BACKGROUND

### Field

The described aspects generally relate to application access in a zero trust network access (ZTNA) network. For example, some aspects of this disclosure relate to providing an agent-based ZTNA user device access to a campus network.

### SUMMARY

Some aspects of this disclosure include apparatuses and methods for application access in a zero trust network access (ZTNA) network, and more specifically, providing an agent-based ZTNA user device access to a campus network.

Some aspects of this disclosure relate to a universal network access application including a memory and a processor. The processor is configured to receive an authentication request from a client device and in response to receiving the authentication request, retrieve a set of network policies indicating an Internet protocol (IP) address and a port number based on the authentication request. In some aspects, the IP address and the port number correspond to either a universal zero trust network access (UZTNA) cloud gateway or a service connector within the campus network. The processor is further configured to transmit the set of network policies to a policy enforcement application in a campus network.

Some aspects of this disclosure relate to a method for a universal network access application. The method includes receiving an authentication request from a client device and in response to receiving the authentication request, retrieving a set of network policies indicating an Internet protocol (IP) address and a port number based on the authentication request. In some aspects, the IP address and the port number correspond to either a UZTNA cloud gateway or a service connector within the campus network. The method further includes transmitting the set of network policies to a policy enforcement application in a campus network.

Some aspects of this disclosure relate to a non-transitory computer-readable medium (CRM) including instructions to, upon execution of the instructions by one or more processors of a universal network access application, cause the universal network access application to perform operations. The operations include receiving an authentication request from a client device and in response to receiving the authentication request, retrieving a set of network policies indicating an Internet protocol (IP) address and a port number based on the authentication request. In some aspects, the IP address and the port number correspond to either a UZTNA cloud gateway or a service connector within the campus network gateway The operations further include transmitting the set of network policies to a policy enforcement application in a campus network.

This Summary is provided merely for purposes of illustrating some aspects to provide an understanding of the subject matter described herein. Accordingly, the above-described features are merely examples and should not be construed to narrow the scope or spirit of the subject matter in this disclosure. Other features, aspects, and advantages of this disclosure will become apparent from the following Detailed Description, Figures, and Claims.

### BRIEF DESCRIPTION OF THE DRAWINGS

The accompanying drawings are incorporated herein and form a part of the specification.

FIG. 1 illustrates an exemplary system that implements an agent-based ZTNA user device access and a campus user device access, according to some aspects.

FIG. 2 illustrates an exemplary system that implements an agent-based ZTNA user device access via a campus network, according to some aspects.

FIG. 3 illustrates a block diagram of apparatuses for application access in a ZTNA network, according to some aspects.

FIG. 4 illustrates an example method of implementing network policies for agent-based ZTNA user device and campus user devices, according to some aspects.

FIG. 5 illustrates an example method of configuring implicit network policies, according to some aspects.

FIG. 6 illustrates an example combined packet for implementing application access in the ZTNA network, according to some aspects of the disclosure.

FIG. 7 illustrates an example computer system for implementing some aspects of the disclosure or portion(s) thereof.

The present disclosure is described with reference to the accompanying drawings. In the drawings, generally, like reference numbers indicate identical or functionally similar elements. Additionally, generally, the left-most digit(s) of a reference number identifies the drawing in which the reference number first appears.

### DETAILED DESCRIPTION

Provided herein are apparatuses and methods for application access in a zero trust network access (ZTNA) network, and more specifically, providing an agent-based ZTNA user device access to a campus network.

A campus network, such as a network serving a corporation or an organization, may be configured with one or more policy enforcement applications, such as switches for wired connections and/or access points (APs) for wireless connections. In some aspects, the campus network is configured with a plurality of network policies that govern types of access and priorities granted to a device connected to the campus network or a packet that arrives at the campus network. For example, an administrator of the campus network may configure a set of network policies that give different groups of devices or different groups of identities different access, resources, and/or priorities. A device in an accounting department may be given access to accounting department related documents. A device in a human resource (HR) department may be given access to HR related documents. In some aspects, when a packet arrives at the campus network, the campus network determines a network policy to be applied to the packet based on a header of the packet. For example, the header of the packet may indicate that the packet is originated from a HR department device.

In some aspects, a user or a device of the user may be authenticated to access the campus network. For example, the device may transmit an authentication request to a policy enforcement application of the campus network. The authentication request may include user name and password, digital certificates, tokens, and/or other information. The policy enforcement application may forward the authentication request to a remote authentication dial-in user service (RADIUS) server, either within the campus network or remoted located. The RADIUS server may compare the authentication request to data stored in a database. In some aspects, the RADIUS may be located within a remote data center (RDC) that includes a database. In such a case, the database may include authentication information of a plurality of users or devices. For example, the database may include the username and the password of the user. Thus, if the user name and the password included in the authentication request match the user name and the password stored in the database, the RADIUS server may authenticate the user and/or the device. Otherwise, the RADIUS server may deny authentication.

In some aspects, once the user or the device is authenticated, the RADIUS server may transmit a set of network policies to the policy enforcement application. The policy enforcement application may then enforce the set of network policies against packets received from the device. For example, if a packet (or a header of the packet) matches a network policy in the set, the policy enforcement application may apply the network policy to the packet. Specifically, the policy enforcement application may deny or allow the packet based on the network policy. On the other hand, if the packet does not match any network policy, the packet will be dropped based on a zero-trust policy. In some aspects, the set of network policies includes a default policy that matches with any packets. When the packet does not match any other policies in the set, the packet still matches the default policy. In such a case, the policy enforcement application may drop the packet based on the default policy. In other words, the default policy may act as a “match-all” policy that drops packets matching no other network policies.

In some aspects, a user may be remotely located from a campus. For example, the user may be at home or traveling. In such a case, the user device is remote and thus not able to directly access the campus network. However, the user device may still be able to access the private DC or the cloud DC without going through the campus network. In some aspects, the user device may be configured with an agent (or a ZTNA agent). The agent may include a software component that establishes a secured and encrypted connection with an end-point. For example, the end-point can be a service connector at the private DC or the cloud DC. The secured and encrypted connection may be an Internet Protocol Security (IPSEC) tunnel. In some aspects, the secured and encrypted connection may be a Wireguard tunnel. However, the aspects of this disclosure are not limited to this example, and the secured and encrypted connection can include other secured and encrypted protocols. In such a case, the agent may encrypt a packet. The user device may then transmit the encrypted packet to a regional DC, which forwards the encrypted packet to the private DC or the cloud DC. Finally, the service connector may decrypt the packet and retrieve the payload. In some aspects, the service connector may provide services to the user device according to the packet. For example, the packet may include a data query for data stored in the private DC or the cloud DC. The service connector may return the requested data to the user device. In such a case, the user device is able to communicate with the private DC or the cloud DC that would otherwise require access to the campus network.

In some aspects, the user may move from a remote location to the campus. For example, the user may return from the travel or go to the campus for the day. In such a case, the user device may connect to the campus network. However, because the agent has been installed on the user device, packets generated by the user device may still be encrypted by the agent. When the packets arrive at the campus network, the policy enforcement application may not be able to apply network policies to the packet. As discussed above, the packet, such as a user packet, is encrypted by the agent of the user device. Because the policy enforcement application may not be able to decrypt the user packet, the policy enforcement application cannot examine the header of the user packet. Consequently, the policy enforcement application cannot match the user packet with any network policies. Thus, based on the zero trust policy, the packets may be dropped and the user device is effectively prevented from sending any packets.

In some aspects, to solve the above issue, the agent may generate an outer header to be attached to the packet after encryption. For example, the outer header may indicate an IP address and a port number corresponding to a relay, such as a cloud relay, a cloud gateway, such as a UZTNA cloud gateway, or a service connector within the campus network discussed below. The policy enforcement application may determine whether to permit or deny the packet based on the IP address and the port number indicated by the outer header, which does not require decrypting the packets. In some aspects, the policy enforcement application may adopt network policies that allow one or more combinations of IP addresses and port numbers. For example, the IP address may be the IP address of the cloud gateway, and the port numbers are designated to the cloud gateway. In some aspects, the cloud gateway forwards the packet to its destination, such as the service connector. If the IP address and the port number of the cloud gateway match a combination, the policy enforcement application may permit the packet and forward the packet toward the cloud gateway. However, this raises another issue because network policies are configured by the administrator. The administrator may not know or require extensive effort and time to acquire the IP address or the port numbers of the cloud gateway of the secured and encrypted connection. In such a case, the administrator may be required to manually configure additional network policies constantly, which is neither efficient nor accurate.

In some aspects, a remote DC (RDC) may include a universal ZTNA (UZTNA) component that is capable of configuring network policies based on IP address and port numbers. The UZTNA component can also be referred to as a universal network access application. For example, the user device may transmit encrypted packets using the IPSEC tunnel via the RDC to the private DC or the cloud DC. Thus, the RDC already knew the IP address and the port numbers of the cloud gateway when the user device is remote. In such a case, when the user device moves to the campus and connects to the campus network, the RDC can inform the campus network regarding the IP address and the port numbers. For example, the UZTNA component may include a Network Policy Engine (NPE) that can generate one or more network policies indicating the IP address and the port numbers. The UZTNA component may also include a RADIUS server that transmits the one or more network policies to the policy enforcement application once the user device is authenticated. In some aspects, the configuration of the one or more network policies may be transparent to the administrator and automatically carried out. Thus, unlike other network policies configured by the administrator, the one or more network policies are implicitly configured. When a packet arrives at the campus network, the policy enforcement application may retrieve the outer header of the packet and determine whether to permit or deny the packet based on the outer header. For example, the policy enforcement application may determine an IP address and a port number based on the outer header and determine whether the IP address and the port number match an implicit network policy. If there is a match, the policy enforcement application may permit the packet and forward it toward the destination. Otherwise, the packet is dropped.

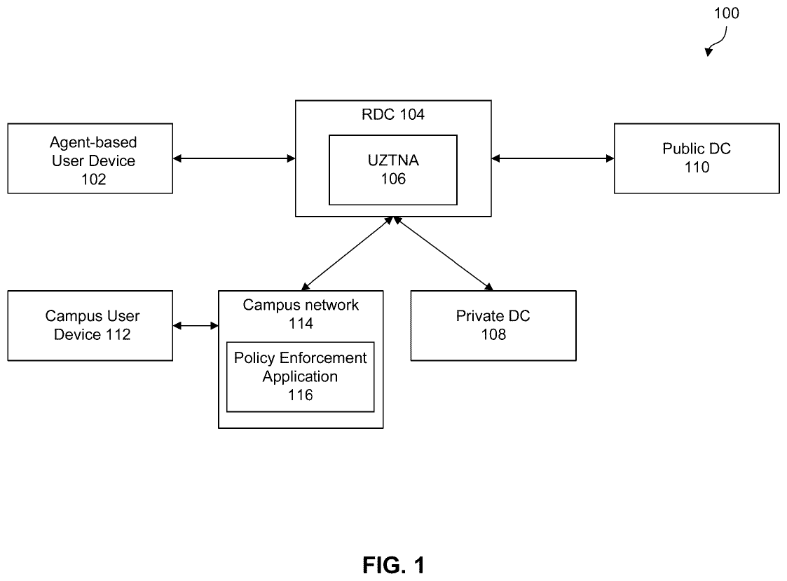

FIG. 1 illustrates an exemplary system 100 that implements an agent-based ZTNA user device access and a campus user device access, according to some aspects. The example system 100 is provided for the purpose of illustration only and does not limit the disclosed aspects. The example system 100 may include, but is not limited to, an agent-based ZTNA user device 102, a RDC 104 that includes a UZTNA 106, a private DC 108, a public DC 110, a campus user device 112, and a campus network 114 that includes a policy enforcement application 116. The policy enforcement application 116 may include a switch and/or an access point (AP) in the campus network 114. In some aspects, the agent-based ZTNA user device 102, the RDC 104, the private DC 108, the public DC 110, the campus user device 112, and the campus network 114 may include, but are not limited to, computer systems, servers, cloud systems, cloud servers, laptops, desktops, personal computers, databases, user equipment, and the like. The public DC 110 can also be a cloud DC. In some aspects, the UZTNA 106 may also be referred to as a universal network access application and the agent-based ZTNA user device 102 and the campus user device 112 may also be referred to as client devices.

In some aspects, the campus user device 112 may need to communicate with the private DC 108 and/or the public DC 110. The campus user device 112 may do so by connecting to the campus network 114. For example, the campus user device 112 may connect to the campus network 114 via a wired or wireless connection. Such a connection may require the campus user device 112 to be within a region of the campus network physically. For example, the campus network 114 may be located in a corporate office. In such a case, the campus user device 112 may be required to be physically present in the corporate office. Once within the corporate office, the campus user device 112 may connect to the campus network 114 via a wired connection, such as an Ethernet cable connection, or a wireless connection, such as a WiFi™ connection. In either case, the campus user device 112 may be authenticated via the policy enforcement application 116 of the campus network 114. For example, the policy enforcement application 116 may receive user name and password from the campus user device 112. The policy enforcement application 116 may then transmit them to the UZTNA 106. In some aspects, the UZTNA 106 includes a RADIUS server that verifies the user name and the password to authenticate the campus user device 112. In some aspects, the RADIUS server may transmit a set of network policies to the policy enforcement application 116 once the campus user device 112 is authenticated.

In some aspects, the policy enforcement application 116 stores the set of network policies after receiving it from the RADIUS server. For example, the set of network policies may indicate that packets of the user identity group are allowed to be forwarded to the RDC 104. In some aspects, the NPE may generate a first portion of the set of network policies according to an administrator of the campus network 114. For example, the administrator may determine and indicate to the NPE that packets of the user identify group are allowed to be forwarded to the RDC 104. The NPE may then generate network policies accordingly and send them to the policy enforcement application 116. The policy enforcement application 116 may process packets once the first portion of the set of network policies is received. For example, the campus user device 112 may transmit the packet toward the private DC 108 or the public DC 110. In some aspects, the policy enforcement application 116 of the campus network 114 may examine the packet to determine how to handle the packet. In some aspects, the policy enforcement application 116 may retrieve a header of the packet and determine that the packet is allowed based on the first portion of the set of network policies. The policy enforcement application 116 may also determine a destination of the packet and forward the packet toward the destination. For example, the policy enforcement application 116 may determine that the destination is the private DC 108 via the RDC 104. In such a case, the policy enforcement application 116 may forward the packet to the RDC 104, which may then forward the packet to the private DC 108. In some aspects, the RDC 104 may further include a relay or a cloud gateway that forwards the packet to the private DC 108.

In some aspects, the agent-based ZTNA user device 102 may also need to communicate with the private DC 108 or the public DC 110. However, the agent-based ZTNA user device 102 may be remotely located. For example, the agent-based ZTNA user device 102 may be located at a residence of a remote employee. In such a case, the agent-based ZTNA user device 102 may not be able to connect to the campus network 114 and thus the packet may not be protected by the authentication process of the campus network 114. Instead, the agent-based ZTNA user device 102 may transmit packets via a secured tunnel, such as an IPSEC tunnel. In some aspects, the agent-based ZTNA user device 102 may establish the IPSEC tunnel with the private DC 108. For example, the agent-based ZTNA user device 102 may install an agent, such as a ZTNA agent, which can encrypt a packet to be transmitted to the private DC 108. Similarly, the private DC 108 may include a service connector that can decrypt the packet once received. In some aspects, the IPSEC tunnel passes through the RDC 104 to reach the private DC 108. The RDC 104 may include the UZTNA 106 that includes a ZTNA cloud gateway (not shown). The ZTNA cloud gateway may examine the packet and forward the packet to the private DC 108. Thus, the UZTNA 106 is aware of the IPSEC tunnel and end points of the IPSEC tunnel, such as the agent-based ZTNA user device 102 and the private DC 108.

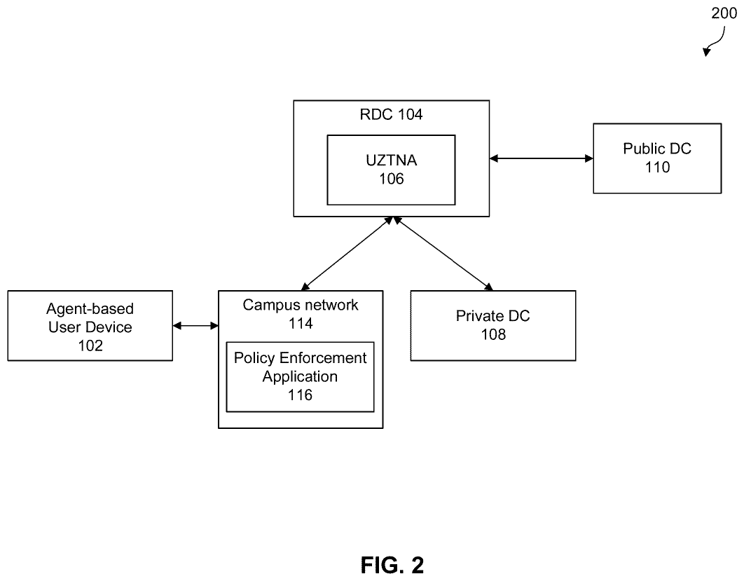

FIG. 2 illustrates an exemplary system 200 that implements an agent-based ZTNA user device access via a campus network, according to some aspects. The example system 200 is provided for the purpose of illustration only and does not limit the disclosed aspects. The example system 200 may include, but is not limited to, an agent-based ZTNA user device 102, a RDC 104 that includes a UZTNA 106, a private DC 108, a public DC 110, and a campus network 114 that includes a policy enforcement application 116. The policy enforcement application 116 may include a switch and/or an access point (AP) in the campus network 114. In some aspects, the agent-based ZTNA user device 102, the RDC 104, the private DC 108, the public DC 110, and the campus network 114 may include, but are not limited to, computer systems, servers, cloud systems, cloud servers, laptops, desktops, personal computers, databases, user equipment, and the like. The public DC 110 can also be a cloud DC. In some aspects, the UZTNA 106 may also be referred to as a universal network access application and the agent-based ZTNA user device 102 and the campus user device 112 may also be referred to as client devices.

In some aspects, the agent-based ZTNA user device 102 may move to the region of the campus network 114. For example, the user of the agent-based ZTNA user device 102 may go to the corporate office for the day. For another example, the user may have been traveling in the past and now returns from the trip. In either case, the agent-based ZTNA user device 102 may be connected to the campus network 114. The agent-based ZTNA user device 102 may be authenticated similarly as the campus user device 112 as discussed above. However, because the agent has been installed and the IPSEC tunnel has been established, when the agent-based ZTNA user device 102 transmits a packet, the agent may encrypt the packet according to the established IPSEC tunnel. However, the policy enforcement application 116 may not be able to analyze the packet because of the encryption. For example, the policy enforcement application 116 may not be able to extract the header or the payload without decrypting the packet. In such a case, the policy enforcement application 116 may not be able to match the packet to any network policies and thus the packet is dropped.

In some aspects, the policy enforcement application 116 may receive a set of implicit network policies from the UZTNA 106 to process encrypted packets, such as the packet encrypted by the agent of the agent-based ZTNA user device 102. For example, the set of implicit network policies may indicate an IP address and port numbers. When the policy enforcement application 116 examines the packet, the policy enforcement application 116 can retrieve an IP address and a port number of the packet and determine whether the IP address and the port number match the implicit network policies. If yes, the policy enforcement application 116 may allow the packet to pass through. In some aspects, packet may include an outer header that indicates the IP address and the port number. The rest of the packet may be encrypted, but the outer header may not be and thus the policy enforcement application 116 can still examine it.

In some aspects, the administrator may not know which IP addresses or port numbers to allow. For example, the agent-based ZTNA user device 102 may be remotely located in the past because the user of the agent-based ZTNA user device 102 may be a remote employee. Thus, the agent-based ZTNA user device 102 may communicate with the private DC 108 or the public DC 110 via the RDC 104 without accessing the campus network 114. In such a case, the administrator of the campus network 114 may not know the IP address and port numbers of a packet destination when the agent-based ZTNA user device 102 connects to the campus network 114. Thus, the administrator may not be able to configure the NPE of the UZTNA 106 to generate network policies regarding packets transmitted by the agent-based ZTNA user device 102.

In some aspects, the RDC 104 may be aware of the agent-based ZTNA user device 102. For example, the RDC 104 may include the UZTNA 106, which includes a network policy engine (NPE) (not shown). The NPE may determine the IP address and port numbers of the packet destination, such as the cloud gateway. In some aspects, the NPE may generate a set of implicit network policies for the agent-based ZTNA user device 102 and other agent-based ZTNA user devices. The NPE may then transmit the set of implicit network policies to the policy enforcement application 116 of the campus network 114. For example, the NPE may transmit a configuration message that includes the set of implicit network policies once the agent-based ZTNA user device 102 is authenticated. The configuration message may include example implicit rules as the following:
Policy-ACL: v:1 t:a,rc m:ipv4dst=3.141.5.153/32,l4dstport=49152-65535,ipproto=udp a:fwd,
Policy-ACL: v:1 t:a,rc m:ipv4dst=18.220.35.74/32,l4dstport=49152-65535,ipproto=udp a:fwd,
Policy-ACL: v:1 t:a,rc m:ipv4dst=18.141.170.43/32,l4dstport=49152-65535,ipproto=udp a:fwd,
Policy-ACL: v:1 t:a,rc m:ipv4dst=54.179.40.140/32,l4dstport=49152-65535,ipproto=udp a:fwd
   Specifically, the first implicit rule indicates an IPv4 address 3.141.5.153/32 and a port number range 49152-65535. Other implicit rules indicate IP addresses and port numbers similarly. Thus, if a packet is transmitted to a destination with the IP address 3.141.5.153/32 and a port number within the port number range, the policy enforcement application 116 of the campus network 114 may allow the packet to pass and be forwarded to the RDC 104.

Another exemplary implicit rule may be class-A, class-B, class-C IP subnets, used for campus IP addressing, are explicitly denied, unless overridden by user-initiated network policy, facilitating campus network resource zero-trust enforcement. In this example, additional, higher precedence, rules are used to permit important control traffic like Dynamic Host Configuration Protocol (DHCP) and Domain Name System (DNS). Other IP subnets are allowed which provide “guest level” internet access can still be used for ZTNA agent communication in a similar way as described above:
Policy-ACL: v: 1t:a,rc m:ipv4dst=192.168.0.0/16 a:deny,
Policy-ACL: v: 1t:a,rc m:ipv4dst=172.16.0.0/12 a:deny,
Policy-ACL: v: 1t:a,rc m:ipv4dst=10.0.0.0/8 a:deny

In either example above, the implicit network policies that allow packets transmitted to the IP address and port numbers may be configured by the NPE automatically, not by the administrator. In some aspects, the implicit network policies may be a second portion of the set of network policies in addition to the first portion of the set of network policies discussed above in FIG. 1. In summary, the set of network policies generated by the NPE may include the first portion that is configured by the administrator, as discussed above in FIG. 1 and the second portion that is generated based on the agent-based ZTNA user device 102 as discussed here. The RADIUS server may transmit the set of network policies that include both the first portion and the second portion to the policy enforcement application 116 once the agent-based ZTNA user device 102 is authenticated. The policy enforcement application 116 can store the set of network policies once receiving it.

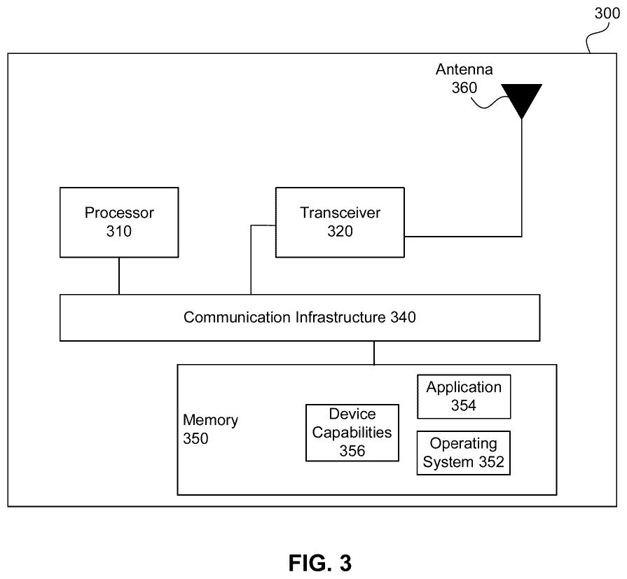

FIG. 3 illustrates a block diagram of apparatuses for application access in a ZTNA network, according to some aspects. The electronic device 300 may be any of the electronic devices (e.g., the agent-based ZTNA user device 102, the RDC 104, the private DC 108, the public DC 110, the campus user device 112, and the campus network 114, or a combination thereof of FIGS. 1 and 2) of the systems 100 and 200. The electronic device 300 includes a processor 310, one or more transceivers 320, a communication infrastructure 340, a memory 350, an operating system 352, an application 354, device capabilities 356, and antenna 360. Illustrated systems are provided as exemplary parts of electronic device 300, and electronic device 300 may include other circuit(s) and subsystem(s). Also, although the systems of electronic device 300 are illustrated as separate components, the aspects of this disclosure may include any combination of these, e.g., less, or more components.

The memory 350 may include random access memory (RAM) and/or cache, and may include control logic (e.g., computer software) and/or data. The memory 350 may include other storage devices or memory. According to some examples, the operating system 352 may be stored in the memory 350. The operating system 352 may manage transfer of data from the memory 350 and/or the one or more applications 354 to the processor 310 and/or the one or more transceivers 320. In some examples, the operating system 352 maintains one or more network protocol stacks (e.g., Internet protocol stack, cellular protocol stack, and the like) that may include a number of logical layers. At corresponding layers of the protocol stack, the operating system 352 includes control mechanisms and data structures to perform the functions associated with that layer.

According to some examples, the application 354 may be stored in the memory 350. The application 354 may include applications (e.g., user applications) used by the electronic device 300 and/or a user of the electronic device 300. In some aspects, the device capabilities 356 may be stored in the memory 350.

The electronic device 300 may also include the communication infrastructure 340. The communication infrastructure 340 provides communication between, for example, the processor 310, the one or more transceivers 320, and the memory 350. In some implementations, the communication infrastructure 340 may be a bus.

The processor 310, alone, or together with instructions stored in the memory 350 performs operations enabling electronic device 300 of the system 100 to implement mechanisms for providing an agent-based ZTNA remote device access to a campus network, as described herein. Alternatively, or additionally, the processor 310 can be “hard coded” to implement mechanisms for providing an agent-based ZTNA remote device access to a campus network, as described herein.

The one or more transceivers 320 transmit and receive communications signals support mechanisms for providing an agent-based ZTNA remote device access to a campus network. Additionally, the one or more transceivers 320 transmit and receive communications signals that support mechanisms for measuring communication link(s), generating and transmitting system information and data, and receiving the system information and data. According to some aspects, the one or more transceivers 320 may be coupled to the antenna 360 to wirelessly transmit and receive the communication signals. The antenna 360 may include one or more antennas that may be the same or different types and can form one or more antenna ports. In some aspects, the antenna 360 can be replaced or used in combination with wired communication interferences, such as Ethernet, Universal Serial Bus (USB), serial port, serial advanced technology attachment (SATA), and fiber optic interferences. The one or more transceivers 320 allow electronic device 300 to communicate with other devices that may be wired and/or wireless. In some examples, the one or more transceivers 320 may include processors, controllers, radios, sockets, plugs, buffers, and like circuits/devices used for connecting to and communication on networks. According to some examples, the one or more transceivers 320 include one or more circuits to connect to and communicate on wired and/or wireless networks.

According to some aspects of this disclosure, the one or more transceivers 320 may include a cellular subsystem, a WLAN subsystem, and/or a Bluetooth™ subsystem, each including its own radio transceiver and protocol(s) as will be understood by those skilled in the arts based on the discussion provided herein. In some implementations, the one or more transceivers 320 may include more or fewer systems for communicating with other devices.

In some examples, the one or more the transceivers 320 may include one or more circuits (including a WLAN transceiver) to enable connection(s) and communication over WLAN networks such as, but not limited to, networks based on standards described in IEEE 802.11.

Additionally, or alternatively, the one or more the transceivers 320 may include one or more circuits (including a Bluetooth™ transceiver) to enable connection(s) and communication based on, for example, Bluetooth™ protocol, the Bluetooth™ Low Energy protocol, or the Bluetooth™ Low Energy Long Range protocol. For example, the transceiver 320 may include a Bluetooth™ transceiver. Additionally, the one or more the transceivers 320 may include one or more circuits (including a cellular transceiver) for connecting to and communicating on cellular networks.

As discussed in more detail below with respect to FIGS. 1, 2, and 4-6, processor 310 may implement different mechanisms for providing an agent-based ZTNA remote device access to a campus network as discussed with respect to the system 100 of FIG. 1 and/or the system 200 of FIG. 2.

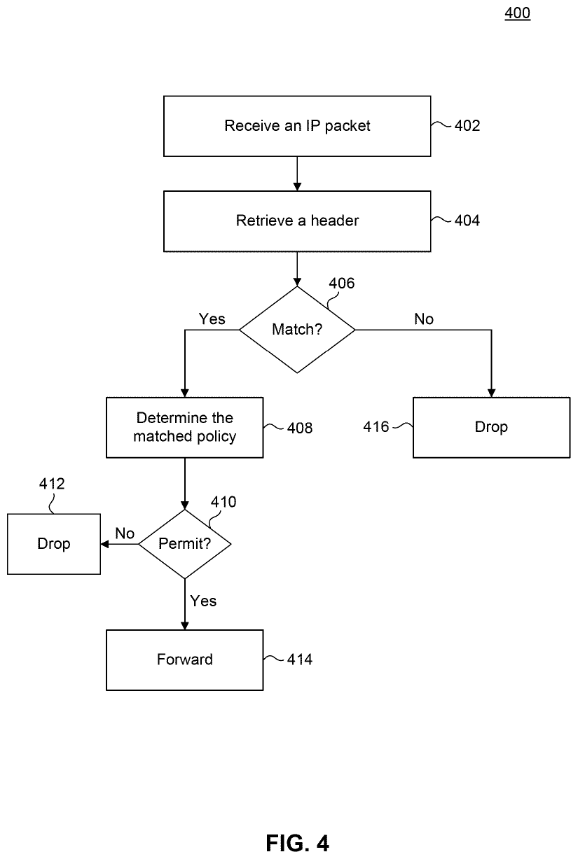

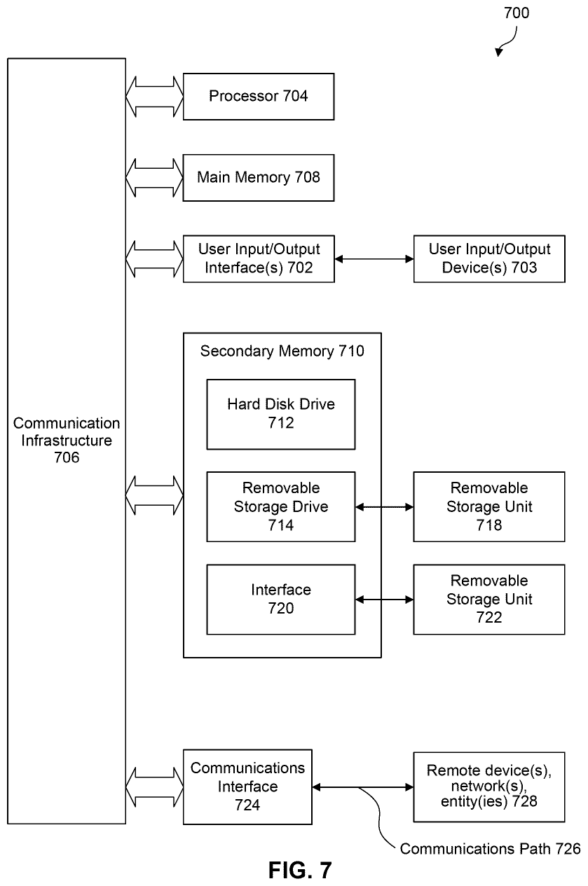

FIG. 4 illustrates an example method 400 of implementing network policies for remote and campus user devices, according to some aspects. As a convenience and not a limitation, FIG. 4 may be described with regard to elements of FIGS. 1, 2, 3, and 7. The example method 400 may represent the operation of devices (e.g., the agent-based ZTNA user device 102, the RDC 104, the private DC 108, the public DC 110, the campus user device 112, and the campus network 114, or a combination thereof of FIGS. 1 and 2) providing an agent-based ZTNA remote device access to a campus network. The example method 400 may also be performed by computer system 700 of FIG. 7. But the example method 400 is not limited to the specific aspects depicted in those figures and other systems may be used to perform the method, as will be understood by those skilled in the art. It is to be appreciated that not all operations may be needed, and the operations may not be performed in the same order as shown in FIG. 4.

At 402, a policy enforcement application may receive a packet, such as an IP packet. In some aspects, the packet may be an IPSEC packet transmitted by an agent-based ZTNA user device, such as the agent-based ZTNA user device 102, to a campus network, such as the campus network 114. The campus network may include the policy enforcement application that receives the IP packet. In some aspects, the policy enforcement application may include a switch or an access point (AP) of the campus network. In other aspects, the policy enforcement application may be located outside of but associated with the switch or the AP.

At 404, the policy enforcement application may retrieve a header file from the packet. The header file may be a number of bytes at the beginning of the packet. In some aspects, the packet may be encrypted by an agent of the agent-based ZTNA user device. For example, the packet may be generated by encrypting an original packet. In such a case, the header may be an outer header that is added after the original packet is encrypted. In other aspects, the packet may be unencrypted and thus is the original packet. Thus, the header is the original header of the original packet. In either case, the policy enforcement application may retrieve the header the same way, e.g., retrieving the number of bytes at the beginning of the packet. In other words, the policy enforcement application processes the packet regardless of whether the packet is encrypted.

At 406, the policy enforcement application determines whether the header matches any network policies. In some aspects, the policy enforcement application receives a set of network policies from a RADIUS server once the agent-based ZTNA user device is authenticated, as discussed above. Thus, the policy enforcement application may compare the header to the set of network policies to determine whether the header matches a network policy in the set of network policies. For example, the header may indicate an IP address and a port number. A network policy in the set may include the IP address and the port number. In such a case, the header matches the network policy. For another example, the header may indicate a medium access control (MAC) address. If a network policy in the set includes the MAC address, there is a match. In some aspects, the set of network polices may include a default policy. As discussed above, if the packet does not match any other network policies in the set, the packet can still match the default policy. However, the default policy may indicate dropping any matching packets. Thus, if the packet matches a network policy in the set that is not the default policy, the control moves to 408.

At 408, the policy enforcement application determines the network policy that applies to the packet. In some aspects, the policy enforcement application may determine that multiple network policies match the header. In such a case, the policy enforcement application may determine one network policy out of the multiple network policies to be applied to the packet. For example, network policies in the set may correspond to respective priorities or orders. When multiple network policies match the header, the policy enforcement application may pick a network policy that has the highest priority or order among the multiple network policies that match.

At 410, the policy enforcement application determines whether the network policy permits the packet. If the network policy permits the packet, the control moves to 414 and the policy enforcement application allows the packet to pass and forward the packet toward a destination. If the network policy does not permit the packet, i.e., deny the packet, the control moves to 412 and the policy enforcement application drops the packet.

Referring back to 406, if no network policy other than the default policy matches the header, the control moves to 416. Based on the zero-trust policy or the default policy, the policy enforcement application may drop the packet because there is a matching network policy.

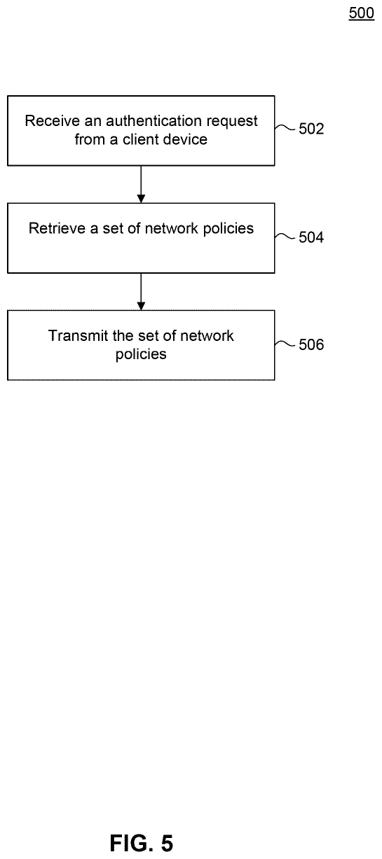

FIG. 5 illustrates an example method 500 of configuring implicit network policies, according to some aspects of the disclosure. As a convenience and not a limitation, FIG. 5 may be described with regard to elements of FIGS. 1, 2, 3, and 7. The example 500 may represent the operation of devices (e.g., the UZTNA 106 of FIGS. 1 and 2) providing an agent-based ZTNA remote device access to a campus network. The example method 500 may also be performed by computer system 700 of FIG. 7. But the example method 500 is not limited to the specific aspects depicted in those figures and other systems may be used to perform the method, as will be understood by those skilled in the art. It is to be appreciated that not all operations may be needed, and the operations may not be performed in the same order as shown in FIG. 5.

At 502, a UZTNA, such as the UZTNA 106, may receive an authentication request from a client device, such as the agent-based ZTNA user device 102. In some aspects, the authentication request may include user name and password, digital certificates, tokens, and/or other information. The client device may transmit the authentication request via a policy enforcement application in the campus network. Furthermore, the authentication request may be processed by a RADIUS server of the UZTNA.

At 504, the UZTNA may retrieve a first set of network policies. In some aspects, the UZTNA may include a NPE. The NPE can generate the first set of network policies that indicates an IP address and a port number of a cloud gateway of the UZTNA. In some aspects, the NPE may receive an instruction from an administrator of a campus network. The NPE may generate a second set of network policies based on the instruction. In some aspects, the first set and the second set are merged into a combined set of network policies. In some aspects, the UZTNA may generate the first set and the second set of network polices and possibly other network policies prior to receiving the authentication request. Thus, the UZTNA may store all network policies in a memory once they are generated. In such a case, the UZTNA may retrieve the first and the second set of network policies from the memory based on the authentication request. For example, the UZTNA can retrieve the first and the second set of network policies in response to authenticating the client device.

At 506, a RADIUS server of the UZTNA may transmit the first set of network policies to the policy enforcement application in the campus network. In some aspects, the RADIUS server may transmit the combined set of network policies that includes the first and the second sets. The first and the second sets of network policies may configure the policy enforcement application to determine whether to permit or deny a packet from the client device. For example, the first and the second sets of network policies may correspond to a header of the packet. In some aspects, the header may include a diffserv code point (DSCP). Thus, when the policy enforcement application receives the packet, the policy enforcement application retrieves the header and determines whether the header matches a network policy out of the first and the second sets of network policies. If there is a match, the policy enforcement application determines whether to permit or deny the packet based on the matching network policy as discussed above. Otherwise, the policy enforcement application drops the packet based on the zero trust policy. In some aspects, the packet may include a registration request for a service from the UZTNA or other device. In some aspects, the RADIUS server may receive an authentication request corresponding to the client device from the policy enforcement application. The RADIUS server may authenticate the client device based on the authentication request and in response to authenticating the client device, transmit the first and the second sets of network policies to the policy enforcement application.

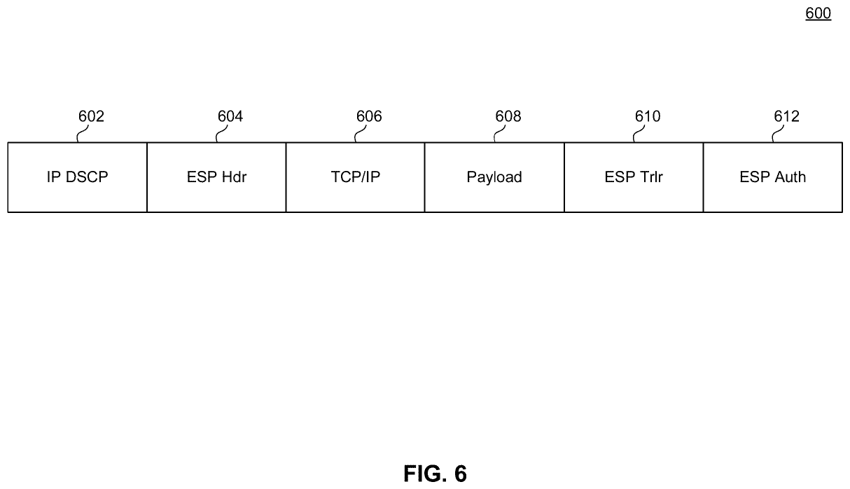

FIG. 6 illustrates an example combined packet 600 for implementing application access in the ZTNA network, according to some aspects of the disclosure. As a convenience and not a limitation, FIG. 6 may be described with regard to elements of FIGS. 1, 2, 3, and 7. The example combined packet 600 may represent a combined packet used during the operation of devices (e.g., the agent-based ZTNA user device 102, the RDC 104, the private DC 108, the public DC 110, the campus user device 112, and the campus network 114, or a combination thereof of FIGS. 1 and 2) providing packets from an agent-based ZTNA user device access in a campus network.

In some aspects, the combined packet 600 may be the IP packet discussed in 402. The combined packet 600 may include an IP DSCP 602, an encapsulating security payload (ESP) header 604, a TCP/IP header 606, a payload 608, an ESP trailer 610, and an ESP authentication 612. In some aspects, the TCP/IP header 606 and the payload 608 may form a packet generated by a user equipment (UE), such as the agent-based ZTNA user device 102. The UE may further encrypt the packet. For example, the agent of the agent-based ZTNA user device 102 may encrypt the TCP/IP header 606 and the payload 608, as discussed above. The UE may then add the ESP header 604, the ESP trailer 610, and an ESP authentication 612 to the encrypted packet.

In some aspects, the ESP header 604 may include information needed for processing the packet, such as the Security Parameters Index (SPI) and the sequence number. The ESP header 604 may also indicate IP addresses and port numbers of a source and a destination. For example, the ESP header 604 may indicate an IP address and a port number of the cloud gateway in FIG. 2, which is a destination of the packet. The ESP trailer 610 may include padding, the next header field, and ensures the payload is properly aligned for encryption algorithms that require data to be in specific block sizes. Finally, the ESP authentication 612 may provide data integrity and authenticity for the ESP header 604, the encrypted packet, and the ESP Trailer 610.

In some aspects, the IP DSCP 602 may be the outer header discussed in 404. The IP DSCP 602 may include a predetermined number of bits, such as 6 bits, and be placed at the beginning of the combined packet. Thus, the policy enforcement application may retrieve the IP DSCP 602 by extracting the predetermined number of bits at the beginning of the combined packet, as discussed in 404.

Various aspects may be implemented, for example, using one or more computer systems, such as computer system 700 shown in FIG. 7. One or more computer systems 700 may be used, for example, to implement any of the aspects discussed herein, as well as combinations and sub-combinations thereof.

Computer system 700 may include one or more processors (also called central processing units, or CPUs), such as a processor 704. Processor 704 may be connected to a communication infrastructure or bus 706.

Computer system 700 may also include user input/output device(s) 703, such as monitors, keyboards, pointing devices, etc., which may communicate with communication infrastructure 706 through user input/output interface(s) 702.

One or more of processors 704 may be a graphics processing unit (GPU). In an aspect, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 700 may also include a main or primary memory 708, such as random access memory (RAM). Main memory 708 may include one or more levels of cache. Main memory 708 may have stored therein control logic (i.e., computer software) and/or data.

Computer system 700 may also include one or more secondary storage devices or memory 710. Secondary memory 710 may include, for example, a hard disk drive 712 and/or a removable storage device or drive 714. Removable storage drive 714 may be a floppy disk drive, a magnetic tape drive, a compact disk drive, an optical storage device, tape backup device, and/or any other storage device/drive.

Removable storage drive 714 may interact with a removable storage unit 718. Removable storage unit 718 may include a computer usable or readable storage device having stored thereon computer software (control logic) and/or data. Removable storage unit 718 may be a floppy disk, magnetic tape, compact disk, DVD, optical storage disk, and/any other computer data storage device. Removable storage drive 714 may read from and/or write to removable storage unit 718.

Secondary memory 710 may include other means, devices, components, instrumentalities or other approaches for allowing computer programs and/or other instructions and/or data to be accessed by computer system 700. Such means, devices, components, instrumentalities or other approaches may include, for example, a removable storage unit 722 and an interface 720. Examples of the removable storage unit 722 and the interface 720 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 700 may further include a communication or network interface 724. Communication interface 724 may enable computer system 700 to communicate and interact with any combination of external devices, external networks, external entities, etc. (individually and collectively referenced by reference number 728). For example, communication interface 724 may allow computer system 700 to communicate with external or remote devices 728 over communications path 726, which may be wired and/or wireless (or a combination thereof), and which may include any combination of LANs, WANs, the Internet, etc. Control logic and/or data may be transmitted to and from computer system 700 via communication path 726.

Computer system 700 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 700 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 700 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some aspects, a tangible, non-transitory apparatus or article of manufacture including a tangible, non-transitory computer useable or readable medium having control logic (software) stored thereon may also be referred to herein as a computer program product or program storage device. This includes, but is not limited to, computer system 700, main memory 708, secondary memory 710, and removable storage units 718 and 722, as well as tangible articles of manufacture embodying any combination of the foregoing. Such control logic, when executed by one or more data processing devices (such as computer system 700), may cause such data processing devices to operate as described herein.

Based on the teachings contained in this disclosure, it will be apparent to persons skilled in the relevant art(s) how to make and use aspects of this disclosure using data processing devices, computer systems and/or computer architectures other than that shown in FIG. 7. In particular, aspects can operate with software, hardware, and/or operating system implementations other than those described herein.

It is to be appreciated that the Detailed Description section, and not any other section, is intended to be used to interpret the claims. Other sections can set forth one or more but not all exemplary aspects as contemplated by the inventor(s), and thus, are not intended to limit this disclosure or the appended claims in any way.

While this disclosure describes exemplary aspects for exemplary fields and applications, it should be understood that the disclosure is not limited thereto. Other aspects and modifications thereto are possible, and are within the scope and spirit of this disclosure. For example, and without limiting the generality of this paragraph, aspects are not limited to the software, hardware, firmware, and/or entities illustrated in the figures and/or described herein. Further, aspects (whether or not explicitly described herein) have significant utility to fields and applications beyond the examples described herein.

Aspects have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative aspects can perform functional blocks, steps, operations, methods, etc. using orderings different than those described herein.

References herein to “one aspect,” “an aspect,” “an example aspect,” or similar phrases, indicate that the aspect described can include a particular feature, structure, or characteristic, but every aspect can not necessarily include the particular feature, structure, or characteristic. Moreover, such phrases are not necessarily referring to the same aspect. Further, when a particular feature, structure, or characteristic is described in connection with an aspect, it would be within the knowledge of persons skilled in the relevant art(s) to incorporate such feature, structure, or characteristic into other aspects whether or not explicitly mentioned or described herein. Additionally, some aspects can be described using the expression “coupled” and “connected” along with their derivatives. These terms are not necessarily intended as synonyms for each other. For example, some aspects can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary aspects, but should be defined only in accordance with the following claims and their equivalents.

What is claimed is:

1. A universal network access application, comprising:
a memory;
at least one processor coupled to the memory and configured to:
receive an authentication request from a client device;
in response to receiving the authentication request, retrieve a set of network policies indicating an Internet protocol (IP) address and a port number based on the authentication request; and
transmit the set of network policies to a policy enforcement application in a campus network.

2. The universal network access application of claim 1, wherein the at least one processor is further configured to:
authenticate the client device based on the authentication request; and
in response to authenticating the client device, transmit the set of network policies to the policy enforcement application.

3. The universal network access application of claim 1,
wherein the client device has established a secured tunnel with a destination device via a cloud gateway of the universal network access application, and
wherein the IP address and the port number correspond to the cloud gateway.

4. The universal network access application of claim 3, wherein the secured tunnel is an Internet protocol security (IPSEC) tunnel or a wireguard tunnel.

5. The universal network access application of claim 1, wherein the at least one processor is further configured to:
receive an instruction from an administrator of the campus network;
generate a second set of network policies based on the instruction; and
transmit the second set of network policies to the policy enforcement application.

6. The universal network access application of claim 1, wherein the set of network policies and the second set of network policies configure the policy enforcement application to determine whether to permit or deny a packet from the client device.

7. The universal network access application of claim 1, wherein the at least one processor is further configured to:
receive a packet from the policy enforcement application; and
forward the packet to a destination device.

8. The universal network access application of claim 7, wherein the first set of rules corresponds to a header of the packet.

9. A method for a universal network access application, comprising:
receiving an authentication request from a client device;
in response to receiving the authentication request, retrieving a set of network policies indicating an Internet protocol (IP) address and a port number based on the authentication request; and
transmitting the set of network policies to a policy enforcement application in a campus network.

10. The method of claim 9, further comprising:
authenticating the client device based on the authentication request; and
in response to authenticating the client device, transmitting the set of network policies to the policy enforcement application.

11. The method of claim 9,
wherein the client device has established an Internet protocol security (IPSEC) tunnel with a destination device via a cloud gateway of the universal network access application, and
wherein the IP address and the port number correspond to the cloud gateway.

12. The method of claim 9, further comprising:
receiving an instruction from an administrator of the campus network;
generating a second set of network policies based on the instruction; and
transmitting the second set of network policies to the policy enforcement application.

13. The method of claim 9, wherein the set of network policies and the second set of network policies configure the policy enforcement application to determine whether to permit or deny a packet from the client device.

14. The method of claim 9, further comprising:
receiving a packet from the policy enforcement application; and
forwarding the packet to a destination device.

15. The method of claim 14, wherein the first set of rules corresponds to a header of the packet.

16. A non-transitory computer-readable medium (CRM) comprising instructions to, upon execution of the instructions by one or more processors of a universal network access application, cause the universal network access application to perform operations, the operations comprising:
receiving an authentication request from a client device;
in response to receiving the authentication request, retrieving a set of network policies indicating an Internet protocol (IP) address and a port number based on the authentication request; and
transmitting the set of network policies to a policy enforcement application in a campus network.

17. The non-transitory CRM of claim 16, wherein the operations further comprise:
authenticating the client device based on the authentication request; and
in response to authenticating the client device, transmitting the set of network policies to the policy enforcement application.

18. The non-transitory CRM of claim 16,
wherein the client device has established an Internet protocol security (IPSEC) tunnel with a destination device via a cloud gateway of the universal network access application, and
wherein the IP address and the port number correspond to the cloud gateway.

19. The non-transitory CRM of claim 16, wherein the operations further comprise:
receiving an instruction from an administrator of the campus network;
generating a second set of network policies based on the instruction; and
transmitting the second set of network policies to the policy enforcement application.

20. The non-transitory CRM of claim 16, wherein the operations further comprise:
receiving a packet from the policy enforcement application; and
forwarding the packet to a destination device, and
wherein the first set of rules corresponds to a header of the packet.
